(19) United States
(12) Patent Application Publication
(10) Pub. No.: US 2021/0405511 A1
(43) Pub. Date: Dec. 30, 2021

(54) Step Release Stand

(71) Applicant: Savage Universal Corp., Chandler, AZ (US)

(72) Inventor: Bo Christensen, Nordborg (DK)

(73) Assignee: Savage Universal Corp

(21) Appl. No.: 16/873,777

(22) Filed: Jun. 30, 2020

(51) Int. Cl. G03B 17/56; F16M 11/14; F16M 11/16; F16M 11/26

(52) U.S. Cl. CPC G03B 17/561; F16M 11/14; F16M 2200/022; F16M 11/26; F16M 11/16

(57) ABSTRACT

An adjustable base configured to allow a user to release the ball joint without using their hands. On the stand member is a foot activated release member which is swivelly secured to the stand member utilizing a spring to keep the foot activated release member in a relaxed state. At one end of the foot member is a ball joint which is released when foot pressure is applied against the foot activated release member.

### PRIORITY

Priority for this application is claimed from U.S. Provisional Application Ser. No. 62/922,029 filed on Jul. 19, 2019 entitled “STEP RELEASE STAND”.

### BACKGROUND OF THE INVENTION

While the discussion herein relates to photography equipment, the invention is not intended to be limited to this field but has applications in other fields and uses as those of ordinary skill art readily recognize.

Within the photography field, there is an elaborate need for stands for lighting, backdrops, reflectors, and the like. Positioning of these stands is often difficult, especially for one person. The position is critical in getting the correct use from the instrument being held, such as a lamp. For this reason, all too often the positioning requires two people; and if the lamp needs to be adjusted later, there is a need to find a second person to help.

It is clear there is a need for an easily adjustable stand.

### SUMMARY OF THE INVENTION

The invention is an adjustable base configured to allow a user to release the ball joint without using their hands. On the stand member is a foot activated release member which is swivelly secured to the stand member utilizing a spring to keep the foot activated release member in a relaxed state. At one end of the foot member is a ball joint which is released when foot pressure is applied against the foot activated release member.

The swivel action is created by a hinge member. A spring on one end of the foot release keeps the ball engaged with the ball tension adjustment screw which is adjustable from the bottom to obtain the tensioning desired by the user.

The step release stand of the present invention is a low-profile stand that feature a step-on released ball joint. The hands-free ball adjustment allows a user to hold, position and lock equipment into position without the need to bend down and loosen the ball joint with one hand. The step-on release mechanism can be used for two different versions of the stand one for a foldable leg version and a second one a disc version.

Ball joints are well known in the art and are used in a variety of fields, including, but not limited to those described in: U.S. Pat. No. 10,524,639, entitled “Medical Device Stand” issued to Khanicheh et al. on Jan. 7, 2020; U.S. Pat. No. 10,474,013, entitled “Utility Mount with Removable Adjustable Ball Joint and Device Mount” issued to Wynalda, Jr. et al. on Nov. 12, 2019; U.S. Pat. No. 5,626,433, entitled “Ball Joint” issued to Iwamoto on May 6, 1997; and, U.S. Pat. No. 5,632,459, entitled “Angle Head Tripod” issued to Brett on May 27, 1997; all of which are incorporated hereinto by reference.

The discussion herein relates to the photographic industry but the invention is not limited to this industry alone.

The adjustable base of this invention includes a spring mechanism interposed between the stand and the second end of the foot activated release member. The spring mechanism maintains the second end of the foot activated release member away from the stand when foot pressure is absent from the second end of the foot activated release member; and is “soft” enough to be readily compressed by foot pressure.

In the preferred embodiment, the bracket portion of the ball joint is tulip shaped. This allows the movement of the ball (with its attendant pole) to ninety-degree intervals.

A tensioning prong is used to engage the ball portion of the ball joint. The tensioning prong applies pressure on the ball portion to press the ball portion against the bracket portion when foot pressure is absent from the second end of the foot activated release member. When foot pressure is present, then the prong acts as a “lock” for the ball joint.

Ideally, the stand uses a “tulip” shaped ball joint which enables easy angled positioning without the need to find the ninety-degree cutout in the ball head housing. The tulip shape relates to the cutouts on the receptacle for the ball. These cutouts involve three cutouts at 120 degrees from each other. This allows the ball, with the attendant attachment, to be placed either a vertical or a horizontal orientation in a single motion.

The ball portion of the ball joint includes an attachment mechanism which is used to receive a pole member to support the attachments contemplated. In the ideal version of the invention, the stand features a ⅝-inch receptacle secured to the ball joint which enables mounting of the most common photographic grip equipment. In the preferred embodiment, a rod clamp is used on the pole member to allow multi-directional positioning.

A variety of base members are contemplated here: extendable legs and circular. Those of ordinary skill in the art readily recognize a variety of other base members.

In the preferred base member, two extendable legs are used. When the legs, are in an extended state, the stand is stabilized. When the legs are collapsed, the stand is easily moved or stored. The foldable leg version uses two legs which, when in the unfolded position, forms a three footed stand with an ideal diameter footprint of sixty centimeters. The stand folds compact for storage or transportation. Its elongated folded configuration makes it an ideal travel companion to be packet together LED light tubes or other poles or stands.

In the preferred embodiment, the legs have holes in them allowing the legs to be screwed into the floor for additional stability. The legs are further ideally dipped in a plastic coating to avoid damaging the floor and are made from hardened steel.

In the other version of the base member, the stand member is circular in shape. The same release mechanism used for the leg version is also used on a circular shaped base. The circular version is preferable for use in situations where the light is included in a shot or when use in events or architectural settings. If the round base/disc and the foot release pedal are black in color, they blend more readily with the surroundings.

The stand of the present invention is ideal to hold the popular LED tubes found throughout the photographic industry. With the stand's quick and hands-free release capability, the use is able to direct and position a light easily without the problems associated with the traditional mounting solutions.

The invention, together with various embodiments thereof, will be more fully explained by the accompanying drawings and the following description thereof.

### DRAWINGS IN BRIEF

FIG. 1 illustrates the foot pedal used to release the ball joint.

FIGS. 2A and 2B illustrate the legged version of the invention in an open and folded state.

FIGS. 3A, 3B, and 3C illustrate the legged version affixed to a pole used to hold a light in this illustration.

### DRAWINGS IN DETAIL

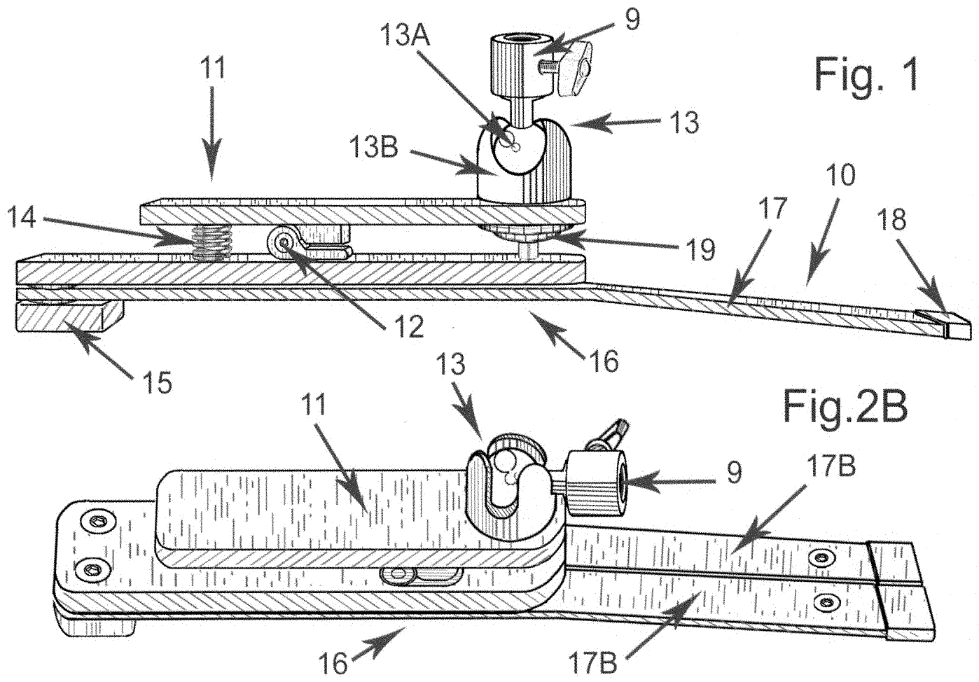

FIG. 1 illustrates the foot pedal used to release the ball joint.

Base member 16 has two legs extending therefrom (only leg 10 is visible in this illustration). Foot activated release 11 is swivelly connected to base member 16 via hinge 12. Spring 14 provides tension on ball joint 13 via ball tensioning prong 19. The height of ball tensioning prong 19 (and by extension the pressure placed upon ball 13A contained within bracket 13B) is adjustable via a screw mechanism (not visible in this illustration) on the bottom of base member 16.

When foot activated release 11 is pressed by an operator's foot, ball member 13A is moved away from ball tensioning prong 19, to ease or release the pressure between ball 13A and bracket 13B, allowing the ball to be rotated.

Both legs (only leg 17 is visible in this illustration) have plastic/rubber dipped tips 18 to keep the legs from damaging the floor. Further, both legs have holes therethrough (not shown) which allow the legs to be screwed into the floor for added bracing. Base member 16 includes a spring ball plunger 15 which keeps the legs in an open position and also provides cushioning for the stand.

Ideally, backet 13B is tulip shaped to enable easy angled positioning without the need to find the ninety-degree cutout in the ball head housing. As noted earlier the tulip shape is named after the cutouts on the receptacle for the ball. Ideally, these cutouts involve three cutouts at 120 degrees from each other. This allows the ball, with the attendant attachment, to be placed either a vertical or a horizontal orientation in a single motion.

Attachment mechanism 9 is shaped to receive a pole so that various implements may be attached thereto as is illustrated in the following drawings.

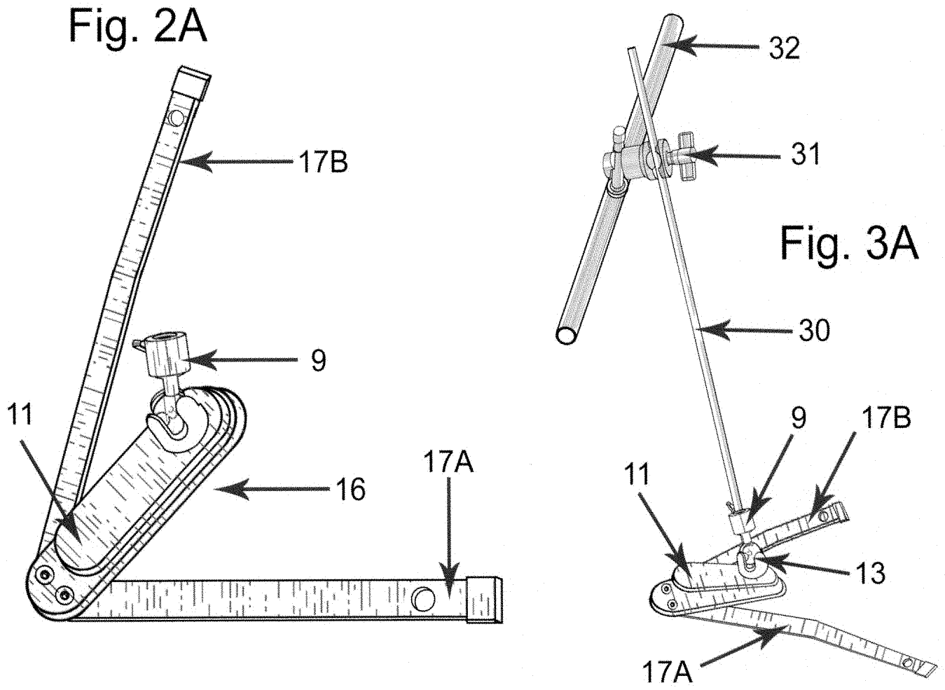

FIGS. 2A and 2B illustrate the legged version of the invention in an open and folded state.

FIG. 2A illustrates the two legged version of the stand in an unfolded state. Ideally the stand creates a sixty-centimeter diameter when fully extended for stability

Base 16, with the foot release 11 is connected to legs 17A and 17B which are in an extended view here.

Legs 17A and 17B fold into base 16 as shown in FIG. 2B. This configuration is ideal for compact storage or transportation of the base. The folded state is also elongated which assists when being transported with LED light tubes as well as other poles or stands.

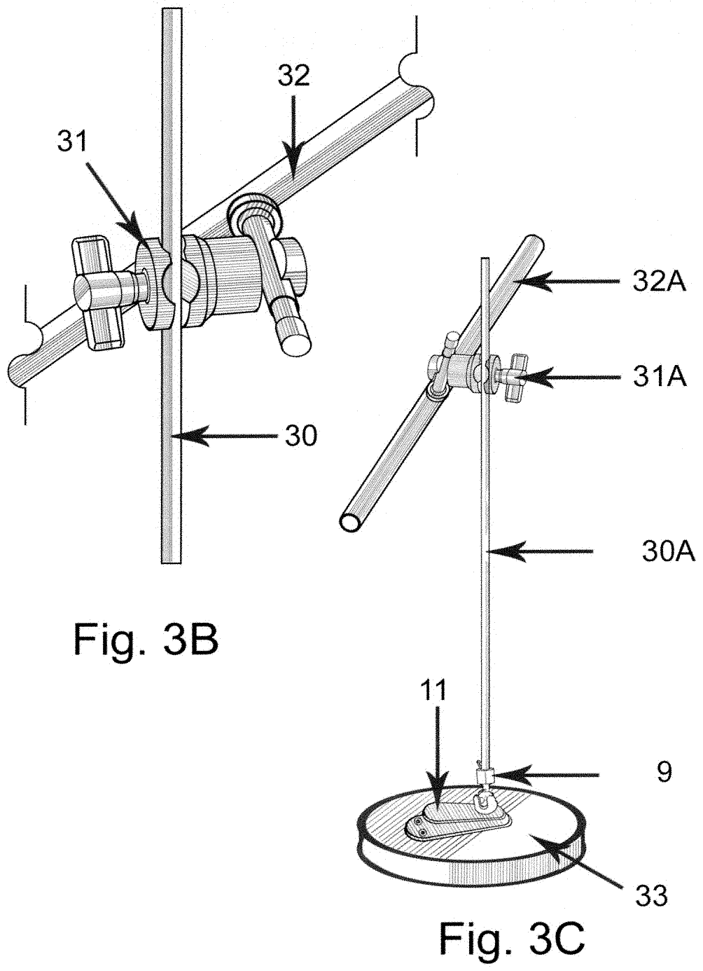

FIGS. 3A, 3B, and 3C illustrate the legged version affixed to a pole used to hold a light in this illustration.

As shown in FIG. 3A, receptacle or attachment mechanism is ideally a ⅝ inch receptacle receiving pole 30. Via attachment 31, LED light 32 is secured to pole 30.

The user, by pressing on foot pedal/release 11, is able to release the ball joint 13, allowing the positioning of pole 30 by hand to obtain the desired position for LED light 32.

Attachment 31 is secured to pole 30 to provide an interconnection with LED light 32, as illustrated in FIG. 3B.

FIG. 3C show an embodiment of the invention which uses a round base 33 with foot release 11 on a top thereof.

Again, pole 30A is secured to receptacle/attachment mechanism 9. Pole 30A is connected, via attachment 31A to LED light 32A. Ideally the round base 33 is black in color as well as the foot release 11. This makes the stan's features less prominent and therefore can be included in situations where the light is included in events or architectural settings.

It is clear that the present invention provides for a highly improved stand which is readily adjustable.

1. An adjustable base comprising:
a) a stand member to rest on a floor;
b) a foot activated release member swivelly secured to the stand member; and,
c) a ball joint having a bracket portion and a ball portion, the bracket portion connected proximate to a first end of the foot activated release member such that foot pressure on a second end of the foot activated release member causes the bracket portion to release the ball portion.

2. The adjustable base according to claim 1, further including a spring mechanism interposed between the stand member and the second end of the foot activated release member, said spring mechanism adapted to maintain the second end of the foot activated release member away from the stand member when foot pressure is absent from the second end of the foot activated release member.

3. The adjustable base according to claim 2, wherein the bracket portion of the ball joint is tulip shaped.

4. The adjustable base according to claim 2, wherein the stand member includes a tensioning prong adapted to engage the ball portion of the ball joint and to apply pressure on the ball portion so as to press the ball portion against the bracket portion when foot pressure is absent from the second end of the foot activated release member.

5. The adjustable base according to claim 4, further including an attachment mechanism secured to the ball portion of the ball joint, said attachment mechanism adapted to receive a pole member.

6. The adjustable base according to claim 4, wherein the stand member includes two extendable legs, said legs, in an extended state, adapted to stabilize the stand member.

7. The adjustable base according to claim 6, wherein the two extendable legs are adapted to fold into a center portion of the stand member.

8. The adjustable base according to claim 4, wherein the stand member is circular in shape.

9. An adjustable base comprising:
a) a stand member;
b) a foot activated release member swivelly secured to the stand member;
c) a spring mechanism interposed between the stand member and the second end of the foot activated release member, said spring mechanism adapted to maintain the second end of the foot activated release member away from the stand member when foot pressure is absent from the second end of the foot activated release member; and,
d) a ball joint having a bracket portion and a ball portion, the bracket portion connected proximate to a first end of the foot activated release member such that foot pressure on a second end of the foot activated release member causes the bracket portion to release the ball portion to move within the bracket portion, the ball portion configured to receive a pole.

10. The adjustable base according to claim 9, wherein the stand member includes a tensioning prong adapted to engage the ball portion of the ball joint and to apply pressure on the ball portion to press the ball portion against the bracket portion when foot pressure is absent from the second end of the foot activated release member.

11. The adjustable base according to claim 10, wherein the bracket portion of the ball joint is tulip shaped.

12. The adjustable base according to claim 10, wherein the stand member includes two extendable legs swivelly connected to a center portion, said legs, in an extended state, said extendable legs adapted to stabilize the stand member, said extendable legs folding into the center portion when said extendable legs are not extended.

13. The adjustable base according to claim 10, wherein the stand member is circular in shape.

14. An adjustable base comprising:
a) a stand member;
b) a foot activated release member swivelly secured to the stand member;
c) a spring mechanism interposed between the stand member and the second end of the foot activated release member, said spring mechanism adapted to maintain the second end of the foot activated release member away from the stand member when foot pressure is absent from the second end of the foot activated release member;
d) a ball joint having a bracket portion and a ball portion, the bracket portion connected proximate to a first end of the foot activated release member such that foot pressure on a second end of the foot activated release member causes the bracket portion to separate from contacting the ball portion; and,
e) a tensioning prong adapted to engage the ball portion of the ball joint and to apply pressure on the ball portion to press the ball portion against the bracket portion when foot pressure is absent from the second end of the foot activated release member.

15. The adjustable base according to claim 14, wherein the tensioning prong is adjustable by an operator.

16. The adjustable base according to claim 15, wherein the stand member includes two extendable legs swivelly connected to a center portion, said legs, in an extended state, said extendable legs adapted to stabilize the stand member, said extendable legs folding into the center portion when said extendable legs are not extended.

17. The adjustable base according to claim 14, wherein the stand member is circular in shape.
